(19) United States
(12) Patent Application Publication
(10) Pub. No.: US 2003/0221692 A1
(43) Pub. Date: Dec. 4, 2003

(54) Sexual aid turntable system

(76) Inventor: Ian M. Jones, Rancho Mirage, CA (US)

Correspondence Address: Michael S. Neustel, Suite No. 4, 2534 South University Drive, Fargo, ND, 58103, US

(21) Appl. No.: 10/161,419

(22) Filed: May 31, 2002

(51) Int. Cl. A61G 15/00

(52) U.S. Cl. 128/845

(57) ABSTRACT

A sexual aid turntable system for providing a new and unusual platform for engaging in sexual acts. The sexual aid turntable system includes a platform with an aperture in the center. This platform is preferably circular and of a sufficient thickness to bear the weight of an individual using the system. The platform is attached to a rotational member which may be a ball thrust bearing assembly, more commonly referred to as a lazy susan bearing assembly. This rotational member is attached to a supporting frame with adjustable height legs. The design allows for the system to be situated above one sexual participant and adjusted to a comfortable height. The other sexual participant then positions himself or herself upon the platform. The system allows for 360° rotation of one participant while the participants are engaging in sexual acts. The design of the system also allows for greater comfort as no weight bearing is required by either participant.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to sexual aid devices and more specifically it relates to a sexual aid turntable system for providing a platform for engaging in sexual acts.

2. Description of the Related Art

Sexual aid devices have been in use for years. Typically, they emphasize enhancing some aspect of sexual interaction. These devices tend to focus solely on stimulation and do not normally involve providing a platform to assist in developing and performing new sexual positions. There are a finite number of sexual positions available to participants without the aid of a platform. In addition, without the assistance of a platform a participant is often required to bear the weight of another participant.

Examples of patented devices which are related to the present invention include U.S. Pat. No. 6,030,039 to Essler; U.S. Pat. No. 3,971,592 to Farley; U.S. Pat. No. 4,825,855 to Kundson; and U.S. Pat. No. 5,294,176 to Asinovsky.

While these devices may be suitable for the particular purpose to which they address, they are not as suitable for providing a new and unusual platform for engaging in sexual acts. These devices focus primarily on weight bearing and sexual positioning, and do not provide a system to augment the physical movement of the participant. Current devices do not provide the ability for 360° axial rotation while engaging in sexual acts.

In these respects, the sexual aid turntable system according to the present invention substantially departs from the conventional concepts and designs of the prior art, and in so doing provides an apparatus primarily developed for the purpose of providing a new and unusual platform for engaging in sexual acts allowing for a 360° axial rotation.

### BRIEF SUMMARY OF THE INVENTION

In view of the foregoing disadvantages inherent in the known types of sexual aid devices now present in the prior art, the present invention provides a new sexual aid turntable system construction wherein the same can be utilized for providing a new and unusual platform for engaging in sexual acts.

The general purpose of the present invention, which will be described subsequently in greater detail, is to provide a new sexual aid turntable system that has many of the advantages of the sexual aid devices mentioned heretofore and many novel features that result in a new sexual aid turntable system which is not anticipated, rendered obvious, suggested, or even implied by any of the prior art sexual aid devices, either alone or in any combination thereof.

To attain this, the present invention generally comprises a rounded platform with an aperture in the center. This platform is attached to a mechanism for attaching the platform a supporting structure which provides for 360° rotation of the platform relative to the supporting structure. Attached to the supporting structure are adjustable height legs.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a sexual aid turntable system that will overcome the shortcomings of the prior art devices.

A second object is to provide a sexual aid turntable system for providing a new and unusual platform for engaging in sexual acts.

Another object is to provide a sexual aid turntable system that allows for 360° axial rotation of one participant during sexual acts.

An additional object is to provide a sexual aid turntable system that allows sexual acts without one participant being required to bear the weight of the other participant.

A further object is to provide a sexual aid turntable system that provides increased sexual pleasure.

Another object is to provide a sexual aid turntable system that allows for new sensations during sexual acts.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an exploded upper perspective view of the present invention.

FIG. 3 is a cross-sectional view taken along line 3-3 of FIG. 1.

FIG. 4 is a lower perspective view of the present invention.

### DETAILED DESCRIPTION OF THE INVENTION

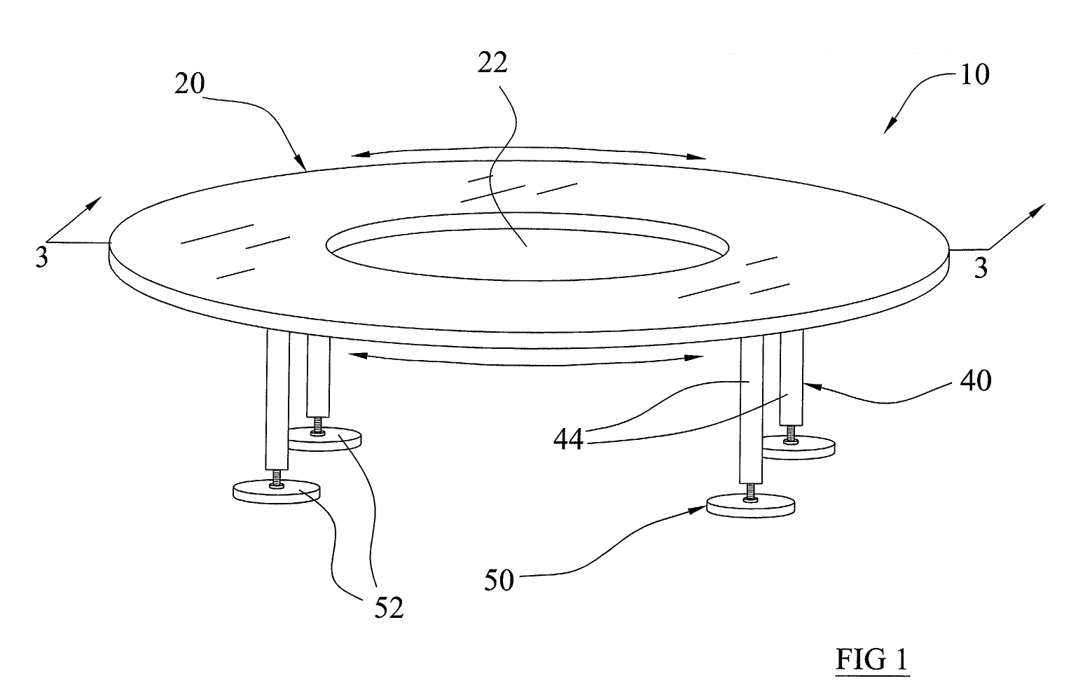

Turning now descriptively to the drawings, in which similar reference characters denote similar elements throughout the several views, FIGS. 1 through 4 illustrate a sexual aid turntable system 10, which comprises a platform 20 with an aperture 22 preferably in the center of the platform 20. This platform 20 is preferably circular and of a sufficient thickness to bear the weight of an individual using the sexual aid turntable system 10. The platform 20 is attached to a ball thrust bearing assembly 30. This ball thrust bearing assembly 30 is correspondingly attached to a supporting frame 40 which includes adjustable feet 50. The sexual aid turntable system 10 can be situated above one sexual participant and adjusted to a comfortable height using the adjustable feet 50. Another sexual participant can then position himself or herself upon the platform 20. The sexual aid turntable system 10 allows for 360° rotation of one participant while the participants are engaging in sexual acts.

The platform 20 is constructed from material with the physical characteristics necessary to support the weight of a sexual participant. As best seen in FIG. 1, the platform 20 is preferably circular-shaped and has an aperture 22 which is additionally preferably circular-shaped and may be centered on the center of the platform 20. The platform 20 is approximately 36 inches in diameter and the aperture 22 is approximately 14½ inches in diameter. However, it can be appreciated by one skilled in the art that the platform 20 can be constructed in variety of different shapes and sizes. Additionally, it can be appreciated by one skilled in the art that the aperture 22 can be constructed in a variety of different shapes and sizes and at different locations relative to the center of the platform 20.

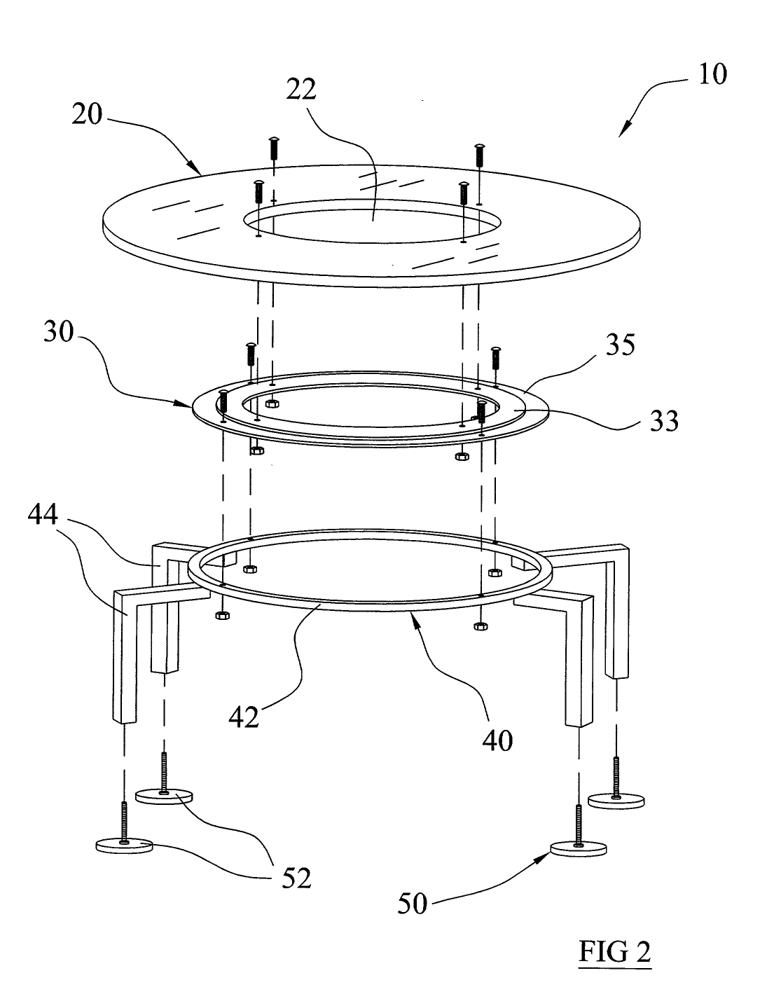

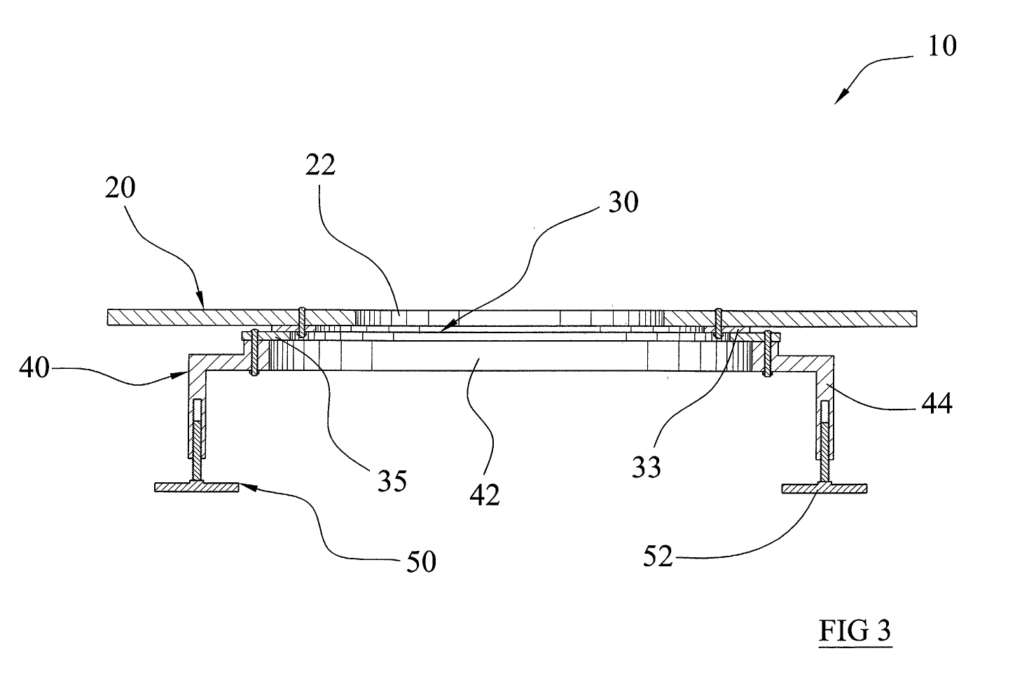

The platform 20, as best seen in FIGS. 2 and 3, is attached to the ball thrust bearing assembly 30. The ball thrust bearing assembly 30 includes an inside race 33 and an outside race 35. The platform 20 may be attached using a variety of different attachment methods to either the inside race 33 or the outside race 35. In addition, it can be appreciated by one skilled in the art that other methods of connecting the platform 20 to the frame 40 may be used to allow rotational movement of the platform 20.

The inside race 33 of the ball thrust bearing assembly 30 is of a diameter equal to or larger than the diameter of the aperture 22. The outside race 35 should be of a diameter less than the outside diameter of the platform 20.

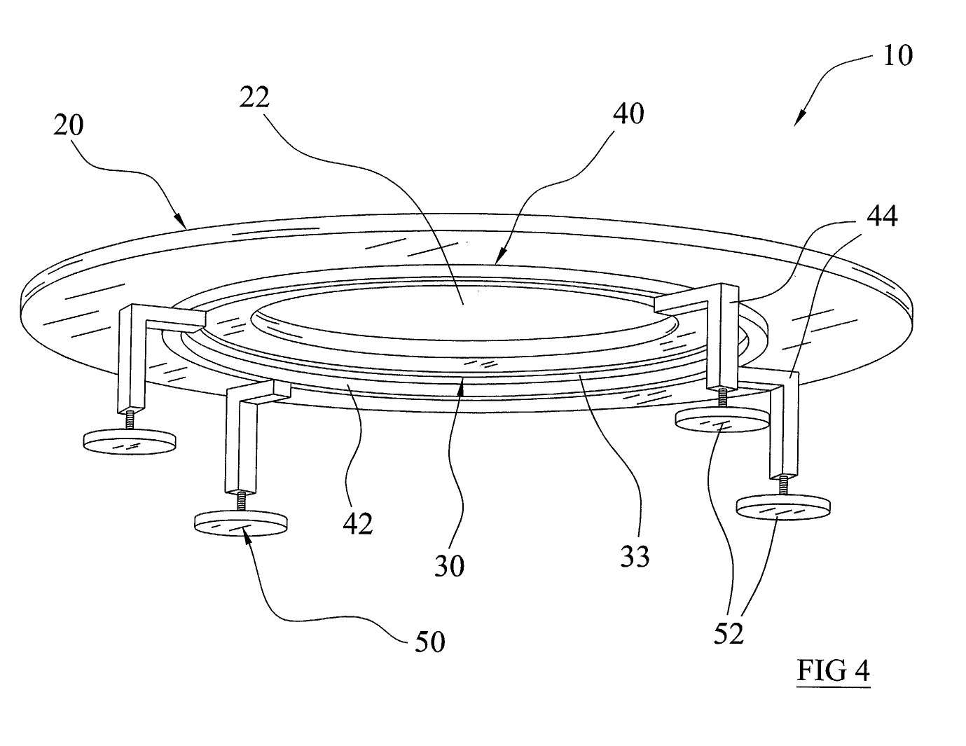

As best seen in FIGS. 2 and 4, the ball thrust bearing assembly 30 is attached to the frame 40. The frame 40 may be attached using a variety of different attachment methods to either the inside race 33 or the outside race 35 of the ball thrust bearing assembly 30 depending on whether the inside race 33 or outside race 35 was previously attached to the platform 20.

The frame 40 comprises a support structure 42 and legs 44. The support structure 42 and legs 44 may be made of metal or any other material capable of bearing the weight of a sexual participant. As best seen in FIG. 4, the support structure 42 is preferably of a shape and size to facilitate the use of the sexual aid turntable system 10.

As best seen in FIG. 3, the legs 44 may be constructed to accept adjustable feet 50. The legs 44 may be hollow to facilitate the use of the adjustable feet 50. The pads 52 of the adjustable feet 50 are preferably constructed of non-slip and flexible material. A screw type fastening system may be used to facilitate raising and lowering the adjustable feet 50. However, it can be appreciated by one skilled in the art that other attachment and adjustment methods can be used to connect, raise and lower the adjustable feet 50 relative to the support structure 42.

In use, a male sexual participant can lie horizontally on their back and center the sexual aid turntable 10 over their penis. The other sexual participant sits on the platform 20 and engages in intercourse. The platform can then be manually rotated while intercourse is occurring. However, it can be appreciated that a plurality of different methods can be used to take advantage of the unique features of the sexual aid turntable 10. In addition, it can be appreciated by one skilled in the art that other means to rotate the turntable can be used.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Sexual Aid Turntable System

□ ENVIRONMENTAL ELEMENTS
□
□
□
□
□
□
□
□
□
□ 10. Sexual Aid Turntable System
□ 11.
□ 12.
□ 13.
□ 14.
□ 15.
□ 16.
□ 17.
□ 18.
□ 19.
□ 20. Platform
□ 21
□ 22. Aperture
□ 23.
□ 24.
□ 25.
□ 26.
□ 27.
□ 28.
□ 29.
□ 30. Ball Thrust Bearing Assembly
□ 31.
□ 32.
□ 33. Inside Race
□ 34.
□ 35. Outside Race
□ 36.
□ 37.
□ 38.
□ 39.
□ 40. Frame
□ 41.
□ 42. Support Structure
□ 43.
□ 44. Legs
□ 45.
□ 46.
□ 47.
□ 48.
□ 49.
□ 50. Adjustable Feet
□ 51.
□ 52. Pads
□ 53.
□ 54.
□ 55.
□ 56.
□ 57.
□ 58.
□ 59.
□ 60.
□ 61.
□ 62.
□ 63.
□ 64.
□ 65.
□ 66.
□ 67.
□ 68.
□ 69.
□ 70.
□ 71.
□ 72.
□ 73.
□ 74.
□ 75.
□ 76.
□ 77.
□ 78.
□ 79.

I claim:

1. A sexual aid turntable system for assisting in the performance of sexual acts, comprising:
a platform having an upper side and a lower side;
an aperture extending concentrically through said platform;
a rotational member attached to said lower side of said platform for allowing rotation of said platform;
a frame attached to rotational member opposite of said platform; and
a plurality of support members affixed to said frame for supporting said platform a finite distance above a ground surface.

2. The sexual aid turntable system of claim 1, wherein said rotational member is a ball thrust bearing.

3. The sexual aid turntable system of claim 1, wherein said platform is circular.

4. The sexual aid turntable system of claim 1, wherein said platform has an outer diameter of approximately 36 inches.

5. The sexual aid turntable system of claim 1, wherein said aperture is approximately 14½ inches in diameter.

6. The sexual aid turntable system of claim 1, wherein said platform is made of wood.

7. The sexual aid turntable system of claim 1, wherein said frame has a circular shape.

8. The sexual aid turntable system of claim 1, wherein said plurality of support members each includes a foot adjustably attached thereto.

9. The sexual aid turntable system of claim 8, wherein each said foot is threadably attached to said support members.

10. A method of engaging in sexual acts, said method comprising the following steps:
(a) providing a platform having an aperture rotatably supported upon an elevated frame structure;
(b) positioning said platform about a first individual;
(c) positioning a second individual upon said platform; and
(d) rotating said platform.

11. A method as recited in claim 10, wherein said aperture is concentric to said platform.

12. A method as recited in claim 10, wherein said platform is circular.

13. A method as recited in claim 10, wherein said frame includes threadable feet for adjusting the height of said platform to a ground surface.

14. A method as recited in claim 10, wherein said platform has an outer diameter of approximately 36 inches.

15. A method as recited in claim 10, wherein said aperture is approximately 14½ inches in diameter.

16. A method of engaging in sexual acts, said method comprising the following steps:
(a) providing a platform having an aperture rotatably supported upon an elevated frame structure;
(b) positioning a first individual beneath said aperture;
(c) positioning a second individual upon said platform; and
(d) rotating said platform.

17. A method as recited in claim 16, wherein said aperture is concentric to said platform.

18. A method as recited in claim 16, wherein said platform is circular.

19. A method as recited in claim 16, wherein said frame includes threadable feet for adjusting the height of said platform to a ground surface.

20. A method as recited in claim 16, wherein said platform has an outer diameter of approximately 36 inches.
